(19) United States
(12) Patent Application Publication
(10) Pub. No.: US 2013/0266383 A1
(43) Pub. Date: Oct. 10, 2013

(54) MATERIAL SURFACE DISTRESSING BLADE

(71) Applicants: Brian W. BEAKLER, York, PA (US); Matthew S. MYERS, Lititz, PA (US)

(72) Inventors: Brian W. BEAKLER, York, PA (US); Matthew S. MYERS, Lititz, PA (US)

(21) Appl. No.: 13/463,984

(22) Filed: May 4, 2012

Related U.S. Application Data
(63) Continuation-in-part of application No. 13/442,966, filed on Apr. 10, 2012.

(51) Int. Cl. B23P 15/28

(52) U.S. Cl. 407/65

(57) ABSTRACT

A blade including a body has a front surface and a curved back cutting surface. The front surface has a mount angle relative to a material surface of a material facing the back cutting surface. The back cutting surface and the front surface define a blade angle. In response to at least one of the blade and the material surface being brought into cutting contact and moved relative to each other, a resulting portion of the material surface has a distressed appearance.

### FIELD OF THE INVENTION

The present invention relates to blades, and more specifically, the present invention relates to blades that are configured to distress a surface of a material.

### BACKGROUND OF THE INVENTION

It has become fashionable to subject furniture and other objects/fixtures or surfaces of walls or flooring of a structure, such as a residence to a design style or technique sometimes referred to as distressing or antiquing. These design styles are intended to “age” the surface of the item or object treated to achieve a unique and/or rustic look. In one aspect of this design style, the surface of the item may be subjected to operations such as sanding, denting, and/or scraping. Typically these types of operations would be performed on furniture or other items, including walls or flooring that are composed of a cellulose-containing material, such as wood and composite board to produce a distressed surface.

Aspects of a distressed surface can include random irregularities formed in the surface of a material, such as variations relating to depth, width and length of the formed surface irregularity by a tool brought into contact with the material surface, as well as random locations along the surface of the material being scraped. In addition, imperfections are typically desirable, and can occur in response to variations, especially abrupt changes, in mechanical properties of a material having a surface to be distressed. Such changes or variations in mechanical properties could relate to density or hardness of the material. Examples include knots, burls and changes in grain direction, such as commonly associated with wood. The desirable appearance of a material surface variation such as a burl, for example, would typically exhibit discontinuities, sometimes referred to as “chattering”, such as formed by a scraping tool in the material surface both prior to and subsequent to a scraping tool encountering the burl.

Known constructions of apparatus have been devised in an attempt to produce materials having the desired aspects associated with a distressed material surface. Such constructions, have included sanding heads having discontinuities formed therein, molded heads that are placed in a pressurized contact with a material surface, as well as embossing drums or plates. However, all known apparatus have failed to produce the desired features associated with a distressed material surface.

A blade that can produce the desired features associated with a distressed material surface in a material would be desirable in the art.

### BRIEF DESCRIPTION OF THE INVENTION

According to an embodiment, a blade includes a body having a front surface and a curved back cutting surface of between about a 12 inch radius and about an 18 inch radius. The front surface has a mount angle of between about 92 degrees and about 98 degrees relative to a material surface of a material facing the back cutting surface. The back cutting surface and the front surface define a blade angle of between about 66 degrees and about 78 degrees. In response to at least one of the blade and the material surface being brought into cutting contact and moved relative to each other, a resulting portion of the material surface is distressed.

According to another embodiment, a blade includes a body having a front surface and a curved back cutting surface of about a 15 inch radius. The front surface has a mount angle of about 96 degrees relative to a material surface of a material facing the back cutting surface. The back cutting surface and the front surface define a blade angle of about 70 degrees. In response to at least one of the blade and the material surface being brought into cutting contact and moved relative to each other, a resulting portion of the material surface is distressed.

According to another embodiment, a method for distressing a surface of a material includes providing a body having a front surface and a curved back cutting surface of between about a 12 inch radius and about an 18 inch radius. The body includes a blade angle subtended between the front surface and the back cutting surface and being between about 66 degrees and about 78 degrees. The method further includes positioning the front surface between about 92 degrees and about 98 degrees relative to a material surface of a material facing the back cutting surface. The method further includes positioning the back cutting surface between about 4 degrees and about 22 degrees relative to the material surface. The method further includes directing the blade and the material surface into cutting contact, and moving at least one of the blade and the material surface relative to each other.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a perspective view of an exemplary blade according to an embodiment of the disclosure.

FIG. 2 illustrates a side view of the blade of FIG. 1, according to an embodiment of the disclosure.

FIG. 3 illustrates a front view of the blade of FIG. 1, according to an embodiment of the disclosure.

Wherever possible, the same reference numbers will be used throughout the drawings to represent the same parts.

### DETAILED DESCRIPTION OF THE INVENTION

Provided is a blade for distressing a surface of a material such as by cutting, which is intended to include scraping. Embodiments of the present disclosure permit fabrication of materials having distressed surfaces not previously available, providing a substantially equal distribution of forces applied to the material surface by the blade. The blade is configured to have an extended life cycle. The blade is configured to be positioned in a substantially fixed orientation relative to the material surface, resulting in an optimum cutting contact with the material surface. It is intended that the term cutting contact include scraping, i.e., that the blade is removing shavings and/or chips from the material surface.

For purposes of the disclosure, a distressed surface is intended to exhibit a number of characteristics or aspects. For example, a distressed surface or material surface having a distressed appearance or the like is intended to include random irregularities formed in the surface of a material, such as variations relating to depth, width and length of the formed surface irregularity, such as by at least one embodiment of a blade of the present disclosure brought into contact with the material surface, as well as random locations along the surface of the material being distressed. In addition, a distressed surface is intended to include imperfections that may occur in response to variations, especially abrupt changes, in mechanical properties of a material having a surface to be distressed. Such changes or variations in mechanical properties could relate to density or hardness of the material. Examples include knots, burls and changes in grain direction, such as commonly associated with wood. With a distressed surface, the desirable appearance of a material surface variation such as a burl, for example, would typically exhibit discontinuities, sometimes referred to as “chattering”, such as formed by an embodiment of a blade of the present disclosure. The discontinuities would be manifested in the material surface at locations both prior to and subsequent to an embodiment of a blade of the present disclosure encountering the burl.

It is to be appreciated that another material may include cellulose-containing materials, such as composite board.

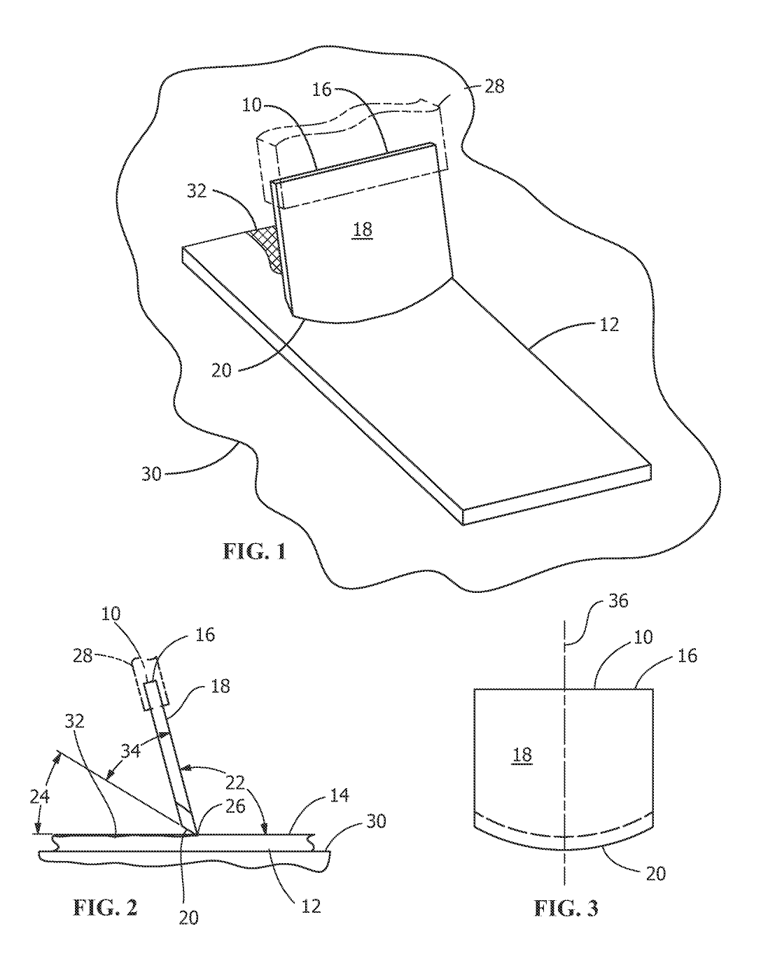

As shown in FIG. 1, a blade 10 of the present disclosure includes a body 16 having a front surface 18 and a back cutting surface 20. Shown opposite back cutting surface 20 is a blade support 28 for blade 10. A material 12, such as a board, includes a surface 14 that is positioned facing back cutting surface 20. As further shown in FIG. 1, material support 30 is provided for supporting material 12. In one embodiment, blade support 28 and material support 30 are interconnected. In use, in response to at least one of blade 10 and material surface 14 being brought into cutting contact and moved relative to each other, a resulting portion of material surface 14 is a distressed surface 32. For purposes of the present disclosure, the terms cutting surface and cutting contact are also intended to include abrading contact, such as scraping surface 14 of material 12.

In one embodiment, blade 10 is constructed of a single, contiguous material, such as a carbide, a steel, such as M2 tool steel, or other suitable material that maintains an edge, even when subjected to impact, such as between the blade and the material surface. In another embodiment, blade 10 may be formed of several materials joined together, such as by welding, or by utilization of coatings, if desired. For example, the blade formed of one or more materials may include carbide tips. It is to be understood that the material, as well as the geometry of the blade and the orientation of the blade relative to the surface of a material brought into cutting contact with the blade, contribute to an increase life cycle of the blade of the present disclosure, as compared to other blade constructions.

As shown in FIGS. 2-3, which are not to scale in order to more clearly show and describe features of the present disclosure, blade 10 includes an acute blade angle 34 subtended between front surface 18 and back cutting surface 20, which surfaces intersect at a point or tip 26. In one embodiment, blade angle 34 is between about 66 degrees and about 78 degrees, between about 66 degrees and about 77 degrees, between about 66 degrees and about 76 degrees, between about 66 degrees and about 75 degrees, between about 66 degrees and about 74 degrees, between about 66 degrees and about 73 degrees, between about 66 degrees and about 72 degrees, between about 66 degrees and about 71 degrees, between about 66 degrees and about 70 degrees, between about 66 degrees and about 69 degrees, between about 66 degrees and about 68 degrees, between about 66 degrees and about 67 degrees, between about 67 degrees and about 78 degrees, between about 67 degrees and about 77 degrees, between about 67 degrees and about 76 degrees, between about 67 degrees and about 75 degrees, between about 67 degrees and about 74 degrees, between about 67 degrees and about 73 degrees, between about 67 degrees and about 72 degrees, between about 67 degrees and about 71 degrees, between about 67 degrees and about 70 degrees, between about 67 degrees and about 69 degrees, between about 67 degrees and about 68 degrees, between about 68 degrees and about 78 degrees, between about 68 degrees and about 77 degrees, between about 68 degrees and about 76 degrees, between about 68 degrees and about 75 degrees, between about 68 degrees and about 74 degrees, between about 68 degrees and about 73 degrees, between about 68 degrees and about 72 degrees, between about 68 degrees and about 71 degrees, between about 68 degrees and about 70 degrees, between about 68 degrees and about 69 degrees, between about 69 degrees and about 78 degrees, between about 69 degrees and about 77 degrees, between about 69 degrees and about 76 degrees, between about 69 degrees and about 75 degrees, between about 69 degrees and about 74 degrees, between about 69 degrees and about 73 degrees, between about 69 degrees and about 72 degrees, between about 69 degrees and about 71 degrees, between about 69 degrees and about 70 degrees, between about 70 degrees and about 78 degrees, between about 70 degrees and about 77 degrees, between about 70 degrees and about 76 degrees, between about 70 degrees and about 75 degrees, between about 70 degrees and about 74 degrees, between about 70 degrees and about 73 degrees, between about 70 degrees and about 72 degrees, between about 70 degrees and about 71 degrees, between about 71 degrees and about 78 degrees, between about 71 degrees and about 77 degrees, between about 71 degrees and about 76 degrees, between about 71 degrees and about 75 degrees, between about 71 degrees and about 74 degrees, between about 71 degrees and about 73 degrees, between about 71 degrees and about 72 degrees, between about 72 degrees and about 78 degrees, between about 72 degrees and about 77 degrees, between about 72 degrees and about 76 degrees, between about 72 degrees and about 75 degrees, between about 72 degrees and about 74 degrees, between about 72 degrees and about 73 degrees, between about 73 degrees and about 78 degrees, between about 73 degrees and about 77 degrees, between about 73 degrees and about 76 degrees, between about 73 degrees and about 75 degrees, between about 73 degrees and about 74 degrees, between about 74 degrees and about 78 degrees, between about 74 degrees and about 77 degrees, between about 74 degrees and about 76 degrees, between about 74 degrees and about 75 degrees, between about 75 degrees and about 78 degrees, between about 75 degrees and about 77 degrees, between about 75 degrees and about 76 degrees, between about 76 degrees and about 78 degrees, between about 76 degrees and about 77 degrees, or any suitable range or sub-range thereof. In one embodiment blade angle 34 is about 66 degrees, about 67 degrees, about 68 degrees, about 69 degrees, about 70 degrees, about 71 degrees, about 72 degrees, about 73 degrees, about 74 degrees, about 75 degrees, about 76 degrees, about 77 degrees, about 78 degrees, or any suitable sub-range thereof. In another embodiment, the magnitude of blade angle 34 can vary within the above referenced ranges, as a function of distance from a central axis 36.

As further shown in the figures, in one embodiment, curved back cutting surface 20 defines a profile of between about a 12 inch radius and about an 18 inch radius, between about a 13 inch radius and about an 18 inch radius, between about a 14 inch radius and about an 18 inch radius, between about a 15 inch radius and about an 18 inch radius, between about a 16 inch radius and about an 18 inch radius, between about a 17 inch radius and about an 18 inch radius, between about a 12 inch radius and about a 17 inch radius, between about a 12 inch radius and about a 16 inch radius, between about a 12 inch radius and about a 15 inch radius, between about a 12 inch radius and about a 14 inch radius, between about a 12 inch radius and about a 13 inch radius, between about a 14 inch radius and about a 17 inch radius, between about a 15 inch radius and about a 16 inch radius, or any suitable range or sub-range thereof. In one embodiment curved back cutting surface 20 defines a profile that has about a 12 inch radius, about a 13 inch radius, about a 14 inch radius, about a 15 inch radius, about a 16 inch radius, about a 17 inch radius, about an 18 inch radius, or any suitable sub-range thereof. In other embodiments, curved back cutting surface 20 can define any radius or non-radial (e.g., oval) curve falling within this range. In another embodiment, as shown in FIG. 3, the profile of curved back cutting surface 20 is symmetric about central axis 36, although in another embodiment, curved back cutting surface 20 contains no axis of symmetry. That is, the amount or degree of curvature of curved back cutting surface 20 can vary, if desired. This range of size of curved back cutting surface 20 encompasses different amounts of curved back cutting surface 20, similarly corresponding to an amount of penetration or depth of a surface of distressed material surface 32 (FIG. 2) from a “pristine” surface 14 of material 12 for a predetermined amount of force directed between blade 10 and surface 14 of material 12.

As shown in FIG. 2, blade 10 includes an obtuse mount angle 22 subtended between front surface 18 and surface 14 of material 12 facing back cutting surface 20, which surfaces intersect at point or tip 26. In one embodiment, blade angle 34 is between about 92 degrees and about 98 degrees, between about 93 degrees and about 98 degrees, between about 94 degrees and about 98 degrees, between about 95 degrees and about 98 degrees, between about 96 degrees and about 98 degrees, between about 97 degrees and about 98 degrees, between about 92 degrees and about 97 degrees, between about 92 degrees and about 96 degrees, between about 92 degrees and about 95 degrees, between about 92 degrees and about 94 degrees, between about 92 degrees and about 93 degrees, between about 93 degrees and about 97 degrees, between about 94 degrees and about 96 degrees, between about 95 degrees and about 96 degrees, or any suitable range or sub-range thereof. In another embodiment, mount angle 22 is about 92 degrees, about 93 degrees, about 94 degrees, about 95 degrees, about 96 degrees, about 97 degrees, about 98 degrees, or any suitable sub-range thereof. Mount angle 22 defines an angular position or orientation of the front surface 18 of blade 10 with respect to surface 14.

As shown in FIG. 2, blade 10 includes acute substrate clearance angle 24 subtended between back cutting surface 20 and surface 14 of material 12. In one embodiment, clearance angle 24 is between about 4 degrees and about 22 degrees, between about 4 degrees and about 21 degrees, between about 5 degrees and about 20 degrees, between about 5 degrees and about 19 degrees, between about 6 degrees and about 19 degrees, between about 7 degrees and about 18 degrees, between about 7 degrees and about 17 degrees, between about 8 degrees and about 17 degrees, between about 9 degrees and about 17 degrees, between about 9 degrees and about 18 degrees, between about 10 degrees and about 18 degrees, between about 10 degrees and about 17 degrees, between about 11 degrees and about 16 degrees, between about 11 degrees and about 15 degrees, between about 12 degrees and about 14 degrees, between about 12 degrees and about 13 degrees, between about 10 degrees and about 22 degrees, between about 12 degrees and about 20 degrees, between about 14 degrees and about 18 degrees, between about 16 degrees and about 17 degrees, or any suitable range or sub-range thereof. In another embodiment, substrate clearance angle 24 is about 4 degrees, about 5 degrees, about 6 degrees, about 7 degrees, about 8 degrees, about 9 degrees, about 10 degrees, about 11 degrees, about 12 degrees, about 13 degrees, about 14 degrees, about 15 degrees, about 16 degrees, about 17 degrees, about 18 degrees, about 19 degrees, about 20 degrees, about 21 degrees, about 22 degrees, or any suitable sub-range thereof. Substrate clearance angle 24 encompasses a range of angular separation between back cutting surface 20 and surface 14 of material 12 which has been shown to substantially prevent an accumulation of removed material from surface 14 between surface 14 and back cutting surface 20 sufficient to “clog” the space defining the angular separation. If the space defining the angular separation becomes clogged, the blade tip 26 may begin to unpredictably engage/disengage surface 14 of material 12. Such unpredictable engagement/disengagement of the blade tip 26 is undesirable when the blade tip 26 is encountering a portion of surface 14 of material 12 having substantially constant mechanical properties.

Mount angle 22, blade angle 34, substrate clearance angle 24 and curved back cutting surface 20 associated with blade 10 and surface 14 of material 12 not only exhibit at least the beneficial results separately, as previously identified, but in combination, also unexpectedly results in optimized operation of the blade during cutting contact between blade 10 and surface 14 of material 12 for forming distressed material surface 32. For example, in response to blade 10 encountering changes in mechanical properties of material 12, such as relating to changes or variations in density or hardness of the material 12, blade 10 exhibits discontinuities, sometimes referred to as “chattering”. That is, the discontinuities are manifested in the material surface at locations both prior to and subsequent to blade 10 encountering such discontinuities. As a result, the blade of the present disclosure, when brought into cutting contact and moved relative to a material surface, such as the surface of a cellulose-containing material, unexpectedly includes a resulting portion of the material surface having a distressed appearance. In one embodiment, surface 14 of material 12 is substantially planar. In another embodiment, surface 14 of material 12 is nonplanar. It is to be understood that blade 10 of the present disclosure can be used to distress nonplanar surfaces if the blade angular relationships or parameters previously discussed, such as mount angle 22 and substrate clearance angle 24 can be maintained.

In addition, a distressed surface is intended to include imperfections that may occur in response to variations, especially abrupt changes, in mechanical properties of a material having a surface to be distressed. Such changes or variations in mechanical properties could relate to density or hardness of the material. Examples include knots, burls and changes in grain direction, such as commonly associated with wood. With a distressed surface, the desirable appearance of a material surface variation such as a burl, for example, would typically exhibit discontinuities, sometimes referred to as “chattering”, such as formed by an embodiment of a blade of the present disclosure. The discontinuities would be manifested in the material surface at locations both prior to and subsequent to an embodiment of a blade of the present disclosure encountering the burl.

It is to be understood that since the angular orientations of the blade are relative to the material surface, there is no set orientation of the material relative to horizontal or vertical reference positioning. That is, the blade and material may be positioned such that chips and/or shavings fall away from the material, due to gravity. In one embodiment the blade can be configured to include a “chip breaker”, if desired, as long as the angular relationships between the blade and the material surface, as previously discussed, are maintained.

It is to be appreciated that the amount of force applied between the blade and the material surface can vary widely, depending upon factors including the density or hardness of the material, the speed of the cutting contact of the blade relative to the speed of the material, as well as other factors.

In one example, a blade composed of M2 tool steel comprises a body having a front surface and a back cutting surface with a 15 inch radius. The front surface has a mount angle of 96 degrees relative to the material surface of the material facing the back cutting surface. The back cutting surface and the front surface define a blade angle of 70 degrees. Under indirect, ongoing comparable testing conditions, the blade has been outlasting another conventional blade arrangement by at least a factor of two times (prior to requiring blade replacement). That is, the above-described blade has been lasting about one hour when subjected to constant use prior to requiring blade replacement, compared to a conventional blade arrangement being subjected to intermittent use and having at least one of a mount angle, a blade angle, and substrate clearance angle falling outside the collective ranges described above. While only being subjected to intermittent use, the conventional blade arrangement has been requiring blade replacement about twice each hour. In other words, not only has the blade of the present disclosure been manifesting a service life or life cycle of about one hour under constant use, but the conventional blade has been manifesting a service life or life cycle of about one half hour after intermittent use. This trend preliminarily suggests the blade of the present disclosure manifests a comparative service life or life cycle of greater than 2:1 over the conventional blade arrangement.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A blade comprising:
a body having a front surface and a curved back cutting surface of between about a 12 inch radius and about an 18 inch radius,
the front surface having a mount angle of between about 92 degrees and about 98 degrees relative to a material surface of a material facing the back cutting surface,
the back cutting surface and the front surface defining a blade angle of between about 66 degrees and about 78 degrees; wherein
in response to at least one of the blade and the material surface being brought into cutting contact and moved relative to each other, a resulting portion of the material surface is distressed.

2. The blade of claim 1, wherein at least a portion of the back cutting surface defines a non-radial curve.

3. The blade of claim 1, wherein the non-radial curve is a portion of an oval.

4. The blade of claim 1, wherein the material is a cellulose-containing material.

5. The blade of claim 1, wherein the back cutting surface is between about a 13 inch radius and about a 17 inch radius.

6. The blade of claim 5, wherein the back cutting surface is between about a 14 inch radius and about a 16 inch radius.

7. The blade of claim 6, wherein the back cutting surface is about a 15 inch radius.

8. The blade of claim 1, wherein the mount angle is between about 93 degrees and about 97 degrees.

9. The blade of claim 8, wherein the mount angle is between about 94 degrees and about 96 degrees.

10. The blade of claim 9, wherein the mount angle is between about 95 degrees and about 96 degrees.

11. The blade of claim 10, wherein the mount angle is about 96 degrees.

12. The blade of claim 1, wherein the blade angle is between about 68 degrees and about 74 degrees.

13. The blade of claim 1, wherein the blade angle is between about 68 degrees and about 72 degrees.

14. The blade of claim 13, wherein the blade angle is about 70 degrees.

15. The blade of claim 1, wherein the material surface is substantially planar.

16. The blade of claim 1, wherein the body is composed of steel.

17. The blade of claim 16, wherein the body is composed of M2 tool steel.

18. A blade comprising:
a body having a front surface and a curved back cutting surface of about a 15 inch radius,
the front surface having a mount angle of about 96 degrees relative to a material surface of a material facing the back cutting surface,
the back cutting surface and the front surface defining a blade angle of about 70 degrees; wherein
in response to at least one of the blade and the material surface being brought into cutting contact and moved relative to each other, a resulting portion of the material surface is distressed.

19. The blade of claim 18, wherein the material surface is substantially planar.

20. A method for distressing a surface of a material comprising:
providing a body having a front surface and a curved back cutting surface of between about a 12 inch radius and about an 18 inch radius, a blade angle subtended between the front surface and the back cutting surface being between about 66 degrees and about 78 degrees;
positioning the front surface between about 92 degrees and about 98 degrees relative to a material surface of a material facing the back cutting surface;
positioning the back cutting surface between about 4 degrees and about 22 degrees relative to the material surface;
directing the blade and the material surface into cutting contact; and
moving at least one of the blade and the material surface relative to each other.
